(19) United States
(12) Patent Application Publication
(10) Pub. No.: US 2019/0105742 A1
(43) Pub. Date: Apr. 11, 2019

(54) METHOD FOR MANUFACTURING HEAT EXCHANGER

(71) Applicant: KEIHIN THERMAL TECHNOLOGY CORPORATION, Oyama-shi (JP)

(72) Inventors: Takashi Terada, Oyama-shi (JP); Kazuyuki Takahashi, Oyama-shi (JP); Hiroshi Otsuki, Oyama-shi (JP); Mana Kobayashi, Oyama-shi (JP)

(73) Assignee: KEIHIN THERMAL TECHNOLOGY CORPORATION, Oyama-shi (JP)

(21) Appl. No.: 16/137,483

(22) Filed: Sep. 20, 2018

(30) Foreign Application Priority Data
Oct. 11, 2017 (JP) 2017-197630

(51) Int. Cl. B23P 15/26; B21D 53/08; B23K 1/00; C23C 10/30; F28F 1/12; F28F 21/08

(52) U.S. Cl. CPC B23P 15/26; B21D 53/085; B23K 1/0012; B05D 1/12; F28F 1/12; F28F 21/084; F28F 21/089; C23C 10/30

(57) ABSTRACT

A method for manufacturing a heat exchanger includes preparing heat exchange tubes by using an aluminum extrudate made of an alloy containing Mn (0.1 to 0.3 mass %), and Cu (0.4 to 0.5 mass %), the balance being Al and unavoidable impurities; preparing fins by using an aluminum bare material made of an alloy containing Mn (1.0 to 1.5 mass %) and Zn (1.2 to 1.8 mass %), the balance being Al and unavoidable impurities; causing Zn, Si, and flux powders to adhere to the outer surfaces of the heat exchange tubes such that the Zn powder adhesion amount becomes 2 to 3 g/m², the Si powder adhesion amount becomes 3 to 6 g/m², and the flux powder adhesion amount becomes 6 to 24 g/m²; and brazing the heat exchange tubes and the fins together by utilizing the Si powder and the flux powder adhered to the outer surfaces of the heat exchange tubes.

### BACKGROUND OF THE INVENTION

The present invention relates to a method for manufacturing a heat exchanger. More particularly, the present invention relates to a method for manufacturing a heat exchanger which is used as a condenser for a car air conditioner mounted on a vehicle such as an automobile.

In this specification and claims, the term “aluminum” encompasses aluminum alloys in addition to pure aluminum. Also, materials represented by chemical symbols represent pure materials, and the term “Al alloy” means an aluminum alloy.

In this specification, the term “spontaneous potential” of a material refers to the electrode potential of the material within an acidic (pH: 3) aqueous solution of 5% NaCl with respect to a saturated calomel electrode (S.C.E.), which serves as a reference electrode.

A heat exchanger having the following structure has been widely known and used as a condenser for a car air conditioner. The heat exchanger has a plurality of flat heat exchange tubes formed from an aluminum extrudate, header tanks, corrugated aluminum fins, and aluminum side plates. The flat heat exchange tubes are disposed at predetermined intervals in their thickness direction such that they have the same longitudinal direction and their width direction coincides with an air-flow direction. The header tanks are disposed at opposite longitudinal ends of the heat exchange tubes such that their longitudinal directions coincide with the direction in which the heat exchange tubes are juxtaposed. Opposite ends of the heat exchange tubes are connected to the corresponding header tanks. Each of the fins is disposed between adjacent heat exchange tubes or on the outer side of the heat exchange tube at each of opposite ends, and is brazed to the corresponding heat exchange tube(s). The side plates are disposed outward of the fins at opposite ends and are brazed to the corresponding fins. Each of the header tanks is composed of a tubular tank body formed of aluminum and closing members formed of aluminum. The tank body is formed by bending, into a tubular shape, an aluminum brazing sheet having a brazing material layer on each of opposite sides thereof and brazing opposite side edges of the sheet which are butted against each other. The tank body has openings at opposite ends thereof. The closing members are brazed to the opposite ends of the tank body so as to close the openings at the opposite ends. The tank body has a plurality of tube insertion holes elongated in the air-flow direction and spaced from one another in the longitudinal direction of the tank body. An end portion of each heat exchange tube is inserted into the corresponding tube insertion hole and is brazed to the tank body.

The present applicant has proposed a method of manufacturing the above-described heat exchanger (see Japanese Patent Application Laid-Open (kokai) No. 2014-238209). The proposed method includes steps of: preparing heat exchange tubes and fins; causing Zn powder and flux powder to adhere to outer surfaces of the heat exchange tubes; and brazing the heat exchange tubes and the fins and forming a Zn diffused layer in an outer surface layer portion of each of the heat exchange tubes. Each of the heat exchange tubes has a wall thickness of 200 μm or less and is formed from an aluminum extrudate made of an alloy containing Mn in an amount of 0.2 to 0.3 mass %, Cu in an amount of 0.05 mass % or less, and Fe in an amount of 0.2 mass % or less, the balance being Al and unavoidable impurities. Each of the fins is formed from a brazing sheet composed of an aluminum core material, and a coating material formed of an aluminum brazing material and covering the opposite sides of the core material. In the step of causing Zn powder and flux powder to adhere to the outer surfaces of the heat exchange tubes, a dispersing liquid is prepared by mixedly dispersing flux powder, and Zn powder having an average particle size of 3 to 5 μm and a largest particle size of less than 10 μm in a binder. The dispersing liquid is applied to the outer surface of each of the heat exchange tubes, and the liquid component of the dispersing liquid is vaporized so as to cause the Zn powder and the flux powder to adhere to the outer surface of each heat exchange tube such that the Zn powder adhesion amount becomes 1 to 3 g/m², the flux powder adhesion amount becomes 15 g/m² or less, and the ratio of the flux powder adhesion amount to the Zn powder adhesion amount (the flux powder adhesion amount/the Zn powder adhesion amount) becomes 1 or higher. In the step of brazing the heat exchange tubes and the fins, the heat exchange tubes and the fins in an assembled condition are heated so as to braze the heat exchange tubes and the fins through utilization of the coating material of the fins and the flux powder adhered to the outer surfaces of the heat exchange tubes and to melt the Zn powder adhered to the outer surfaces of the heat exchange tubes so as to diffuse Zn into outer surface layer portions of the heat exchange tubes, thereby forming Zn diffused layers in the outer surface layer portions of the heat exchange tubes.

In manufacture of the heat exchanger by the method described in the publication, the heat exchange tubes and the fins are joined by a brazing material melted out from the coating material of the brazing sheet for forming the fins.

In recent years, a heat exchanger whose fins have enhanced corrosion resistance has been demanded.

### SUMMARY OF THE INVENTION

The present invention has been accomplished in view of the above-described circumstances, and its object is to provide a method for manufacturing a heat exchanger which can further improve the corrosion resistance of fins.

A heat exchanger manufacturing method according to the present invention is a method for manufacturing a heat exchanger which includes heat exchange tubes made of aluminum and fins made of aluminum and brazed to the heat exchange tubes.

The method comprises:

preparing heat exchange tubes formed from an aluminum extrudate made of an alloy containing Mn in an amount of 0.1 to 0.3 mass %, Cu in an amount of 0.4 to 0.5 mass %, Si in an amount of 0.2 mass % or less, Fe in an amount of 0.2 mass % or less, Zn in an amount of 0.05 mass % or less, and Ti in an amount of 0.05 mass % or less, the balance being Al and unavoidable impurities;

preparing fins formed from an aluminum bare material made of an alloy containing Mn in an amount of 1.0 to 1.5 mass %, Zn in an amount of 1.2 to 1.8 mass %, Si in an amount of 0.6 mass % or less, Fe in an amount of 0.5 mass % or less, and Cu in an amount of 0.05 mass % or less, the balance being Al and unavoidable impurities;

applying a dispersing liquid, which is prepared by mixedly dispersing Zn powder, Si powder, and flux powder in a binder, to outer surfaces of the heat exchange tubes and vaporizing a liquid component in the dispersing liquid, thereby causing the Zn powder, the Si powder, and the flux powder to adhere to the outer surfaces of the heat exchange tubes such that the amount of adhered Zn powder becomes 2 to 3 g/m², the amount of adhered Si powder becomes 3 to 6 g/m², and the amount of adhered flux powder becomes 6 to 24 g/m²; and

heating an assembly of the heat exchange tubes and the fins within a brazing furnace so as to braze the heat exchange tubes and the fins together by utilizing the Si powder and the flux powder adhered to the outer surfaces of the heat exchange tubes.

### BRIEF DESCRIPTION OF THE DRAWINGS

FIG. 1 is a perspective view showing the overall structure of a condenser for a car air conditioner which is manufactured by a method of the present invention;

FIG. 2 is an enlarged sectional view showing a portion of the wall of a heat exchange tube of the condenser of FIG. 1; and

FIG. 3 is an enlarged sectional view showing a region of the condenser of FIG. 1 where a heat exchange tube and a corrugated fin is brazed to each other.

### DESCRIPTION OF THE PREFERRED EMBODIMENT

An embodiment of the present invention will next be described with reference to the drawings. In the embodiment, the method of the present invention is applied to manufacture of a condenser for a car air conditioner.

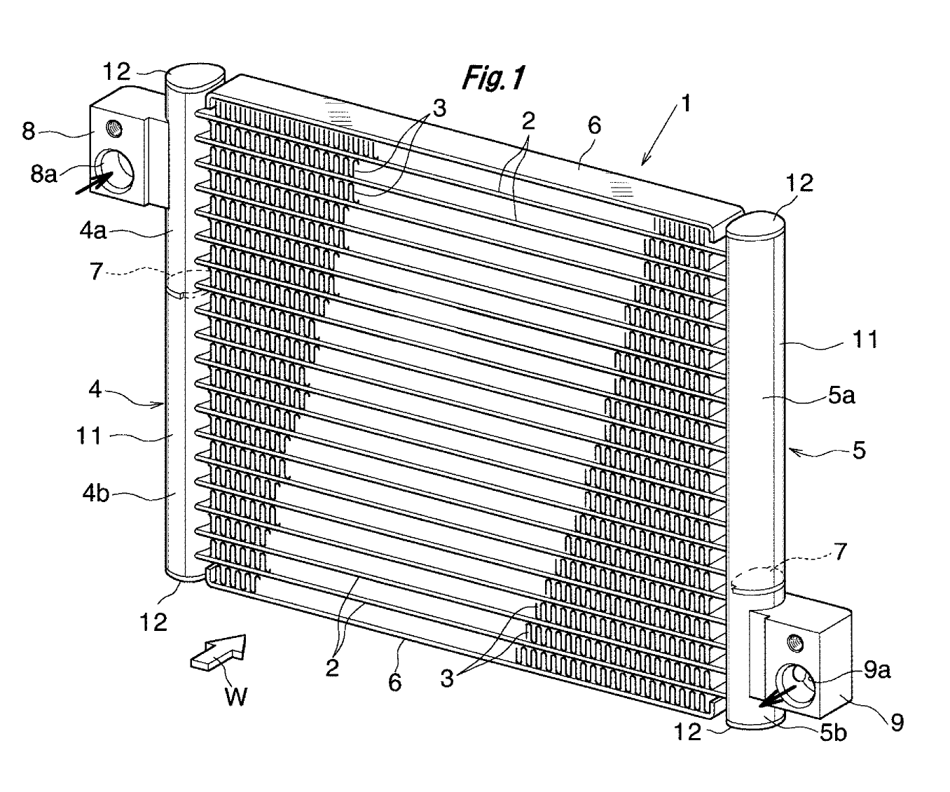

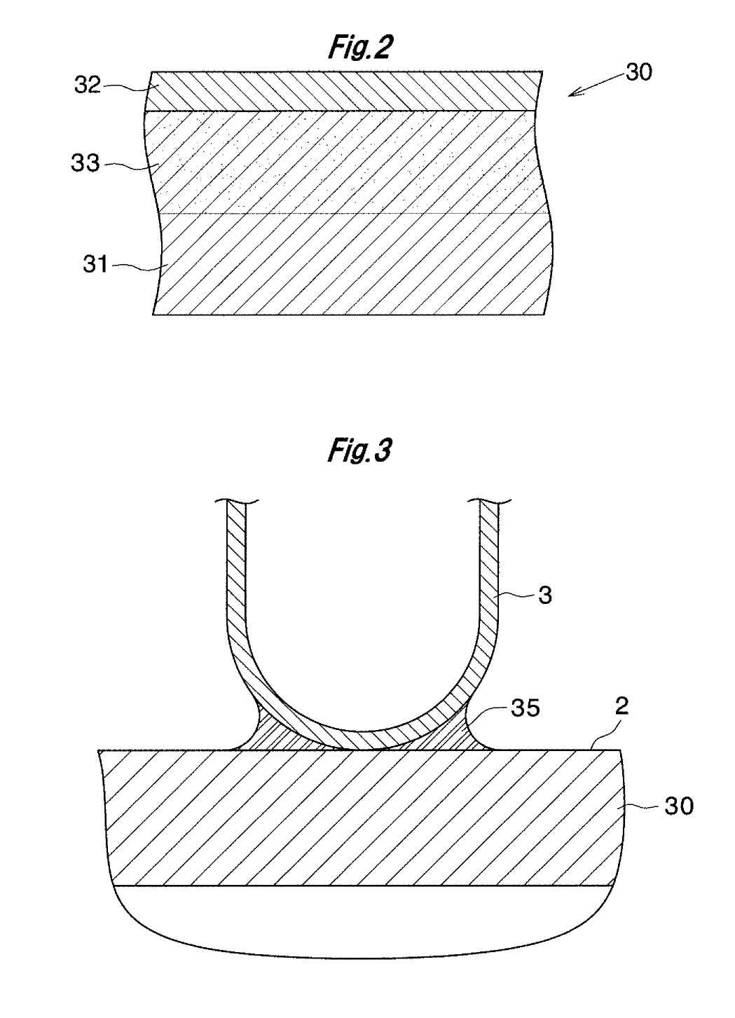

FIG. 1 shows the overall structure of a condenser for a car air conditioner which is manufactured by a method of the present invention, and FIGS. 2 and 3 show the structure of characteristic portions of the condenser.

Notably, in the following description, the upper, lower, left-hand, and right-hand sides of FIG. 1 will be referred to as “upper,” “lower,” “left,” and “right,” respectively.

As shown in FIG. 1, a condenser 1 for a car air conditioner includes a plurality of flat heat exchange tubes 2 formed from an aluminum extrudate, corrugated fins 3 each formed of an aluminum bare material, a pair of header tanks 4 and 5 formed of aluminum, and side plates 6 formed from an aluminum brazing sheet. The heat exchange tubes 2 are disposed at predetermined intervals in the vertical direction (the thickness direction of the heat exchange tubes 2) in such a manner that their longitudinal direction coincides with the left-right direction and their width direction coincides with an air-passing direction. The corrugated fins 3 are disposed between adjacent heat exchange tubes 2 and on the outer sides of the uppermost and lowermost heat exchange tubes 2, and are brazed to the corresponding heat exchange tubes 2. The header tanks 4 and 5 are disposed at a predetermined interval in the left-right direction in such a manner that their longitudinal direction coincides with the vertical direction (the direction in which the heat exchange tubes 2 are juxtaposed). Left and right end portions of the heat exchange tubes 2 are connected to the header tanks 4 and 5, respectively. The side plates 6 are disposed on the outer sides of the uppermost and lowermost corrugated fins 3, and are brazed to the corresponding corrugated fins 3. Air flows in a direction indicated by an arrow W in FIG. 1.

The left header tank 4 is divided by a partition plate 7 into upper and lower header sections 4a and 4b, at a position higher than the center of the left header tank 4 in the height direction. The right header tank 5 is divided by another partition plate 7 into upper and lower header sections 5a and 5b, at a position lower than the center of the right header tank 5 in the height direction. A refrigerant inlet (not shown) is formed at the upper header section 4a of the left header tank 4, and an aluminum inlet member 8 having an inflow passage 8a communicating with the refrigerant inlet is brazed to the upper header section 4a. A refrigerant outlet (not shown) is formed at the lower header section 5b of the right header tank 5, and an aluminum outlet member 9 having an outflow passage 9a communicating with the refrigerant outlet is brazed to the lower header section 5b. Refrigerant having flowed into the upper header section 4a of the left header tank 4 through the inflow passage 8a of the inlet member 8 flows rightward within the heat exchange tubes 2 located above the partition plate 7 of the left header tank 4, and flows into an upper portion of the upper header section 5a of the right header tank 5. The refrigerant then flows downward within the upper header section 5a, flows leftward within the heat exchange tubes 2 whose vertical positions are located between the partition plate 7 of the left header tank 4 and the partition plate 7 of the right header tank 5, and flows into an upper portion of the lower header section 4b of the left header tank 4. The refrigerant then flows downward within the lower header section 4b, flows rightward within the heat exchange tubes 2 located below the partition plate 7 of the right header tank 5, and flows into the lower header section 5b of the right header tank 5. The refrigerant then flows to the outside of the condenser 1 through the outflow passage 9a of the outlet member 9.

Each of the left and right header tanks 4 and 5 is composed of a tank body 11 and a closing members 12. The tank body 11 is formed from an aluminum pipe having a brazing material layer on at least an outer surface thereof; for example, a tubular member formed by bending an aluminum brazing sheet having a brazing material layer on each of opposite sides thereof into a tubular shape and brazing side edges thereof which overlap each other. The tank body 11 has a plurality of tube insertion holes elongated in the air-flow direction. The closing members 12 are made of aluminum and are brazed to the opposite ends of the tank body 11 so as to close the openings at the opposite ends. A detailed illustration of the header tank body 11 is omitted. Also, the header tank body 11 may be formed from a tubular aluminum extrudate having a brazing material thermally sprayed to an outer circumferential surface thereof.

In brief, the condenser 1 is manufactured by a method which includes causing Zn powder, Si powder, and flux powder to adhere to the outer surfaces of the heat exchange tubes 2 formed from an extrudate made of an Al alloy, and heating the heat exchange tubes 2 and the corrugated fins 3 in a brazing furnace so as to join the heat exchange tubes 2 and the corrugated fins 3 together by using a brazing material composed of Al contained in the Al alloy forming the aluminum extrudate (the heat exchange tubes 2) and Si of the Si powder caused to adhere to the surfaces of the heat exchange tubes 2 before joining. Accordingly, as shown in FIGS. 2 and 3, each heat exchange tube 2 has a wall 30 which is composed of a main body portion 31 made of the Al alloy forming the aluminum extrudate (the heat exchange tubes 2) and a covering layer 32 made of an Al—Si—Cu—Zn alloy and covering the outer surface of the main body portion 31. A diffusion layer 33 containing Zn, Si and Cu diffused from the covering layer 32 is formed in an outer surface layer portion of the main body portion 31 of the wall 30 of each heat exchange tube 2. Further, a fillet 35 made of the Al—Si—Cu—Zn alloy is formed in a region where a heat exchange tube 2 and a corrugated fin 3 are brazed together.

The method for manufacturing the condenser will now be described in detail.

First, there are prepared the heat exchange tubes 2 formed from an aluminum extrudate; the corrugated fins 3 formed from an aluminum bare material; the side plates 6, the partition plates 7, the closing members 12, the inlet member 8, and the outlet member 9 which are made of appropriate aluminum; and a pair of tubular aluminum header tank body intermediates having an appropriate material quality and a brazing material layer on at least the outer surfaces thereof. The aluminum extrudate is made of an alloy which has an Mn content of 0.1 to 0.3 mass %, a Cu content of 0.4 to 0.5 mass %, an Si content of 0.2 mass % or less, an Fe content of 0.2 mass % or less, a Zn content of 0.05 mass % or less, and a Ti content of 0.05 mass % or less, the balance being Al and unavoidable impurities. The aluminum bare material is made of an alloy which has an Mn content of 1.0 to 1.5 mass %, a Zn content of 1.2 to 1.8 mass %, an Si content of 0.6 mass % or less, an Fe content of 0.5 mass % or less, and a Cu content of 0.05 mass % or less, the balance being Al and unavoidable impurities. The header tank body intermediates have a plurality of tube insertion holes formed therein. The Al alloy forming the heat exchange tubes 2 is an alloy which is usually used for extrudate-made heat exchange tubes, and the Al alloy forming the corrugated fins 3 is an alloy which is usually used for bare material-made fins.

As described above, when the heat exchange tubes 2 and the corrugated fins 3 are brazed together, Cu contained in the alloy forming the heat exchange tubes 2 enters the fillets 35 formed in the brazing regions between the heat exchange tubes 2 and the corrugated fins 3 and exhibits the effect of making the spontaneous potential of the fillets 35 higher than the spontaneous potential of the corrugated fins 3. However, at a Cu content of less than 0.4 mass %, the effect is not yielded. At a Cu content in excess of 0.5 mass %, the corrosion speed of the heat exchange tubes 2 increases. Therefore, the Cu content is set to 0.4 to 0.5 mass %.

Mn contained in the alloy forming the heat exchange tubes 2 has a characteristic of improving the strength of the heat exchange tubes 2. However, at an Mn content of less than 0.1 mass %, the effect is not yielded. At an Mn content in excess of 0.3 mass %, extrusion workability deteriorates. Therefore, the Mn content is set to 0.1 to 0.3 mass %.

Si, Fe, Zn, and Ti in the alloy forming the heat exchange tubes 2 are impurities, and their individual contents may be zero in some cases. At a Si or Fe content in excess of 0.2 mass %, the corrosion resistance of the heat exchange tube 2 deteriorates. At a Zn content in excess of 0.05 mass %, the self-corrosion resistance of the fines deteriorates. At a Ti content in excess of 0.05 mass %, cost increases. Notably, the alloy forming the heat exchange tubes 2 may contain unavoidable impurities other than Si, Fe, Zn, and Ti such that individual contents are 0.05 mass % or less (including zero mass %) and such that the total content is 0.15 mass % or less.

Mn contained in the alloy forming the corrugated fins 3 has a characteristic of improving the strength of the corrugated fins 3. However, at an Mn content of less than 1.0 mass %, the effect is not yielded. At an Mn content in excess of 1.5 mass %, workability deteriorates. Therefore, the Mn content is set to 1.0 to 1.5 mass %.

Zn contained in the alloy forming the corrugated fins 3 has a characteristic of appropriately maintaining the potential balance between the spontaneous potential of the corrugated fins 3 and the spontaneous potential of the heat exchange tubes 2. However, at a Zn content of less than 1.2 mass %, the effect is not yielded. At a Zn content in excess of 1.8 mass %, corrosion of the corrugated fins 3 becomes severe. Therefore, the Zn content is set to 1.2 to 1.8 mass %.

Si, Fe, and Cu in the alloy forming the corrugated fins 3 are impurities, and their individual contents may be zero in some cases. At an Si, Fe, or Cu content in excess of an upper limit, the corrosion speed of the corrugated fins 3 increases. Notably, the alloy forming the corrugated fins 3 may contain unavoidable impurities other than Si, Fe, and Cu such that individual contents are 0.05 mass % or less (including zero mass %) and such that the total content is 0.15 mass % or less.

Also, a dispersing liquid is prepared by mixedly dispersing flux powder, Zn powder, and Si powder in a binder. The Zn powder has an average particle size of 2 to 6 μm and a maximum particle size of less than 10 μm. The Si powder has an average particle size of 2 to 6 μm and a maximum particle size of less than 10 μm. The flux powder is of, for example, fluoride-based noncorrosive flux containing a mixture of KAlF₄ and KAlF₅ as a main component. The binder is, for example, a solution prepared by dissolving acrylic resin in 3-methoxy-3-methyl-1-butanol. Notably, in order to adjust the viscosity of the binder, a diluent of, for example, 3-methoxy-3-methyl-1-butanol is added to the dispersing liquid.

Next, the dispersing liquid is applied to the outer surface of each heat exchange tube 2, and the liquid component of the dispersing liquid is vaporized so as to cause the Zn powder, the Si powder, and the flux powder to adhere to the outer surface of each heat exchange tube 2 such that the Zn powder adhesion amount becomes 2 to 3 g/m², the Si powder adhesion amount becomes 3 to 6 g/m², and the flux powder adhesion amount becomes 6 to 24 g/m². A method of causing the Zn powder, the Si powder, and the flux powder to adhere to the outer surface of each heat exchange tube 2 is as follows: the dispersing liquid is applied to the outer surface of each heat exchange tube 2 by a spraying process, and subsequently, each heat exchange tube 2 is dried through application of heat for vaporizing the liquid component of the dispersing liquid, thereby causing the Zn powder, the Si powder, and the flux powder to adhere to the outer surface of each heat exchange tube 2; alternatively, the dispersing liquid is applied to the preheated outer surface of each heat exchange tube 2 by a roll coating process, and subsequently, each heat exchange tube 2 is dried through application of heat for vaporizing the liquid component of the dispersing liquid, thereby causing the Zn powder, the Si powder, and the flux powder to adhere to the outer surface of each heat exchange tube 2.

The Zn powder adhered to the outer surface of each heat exchange tube 2 has the following characteristic. During brazing, Zn contained in the Zn powder diffuses from the outer surface of the wall 30 of the heat exchange tube 2, so that the Zn concentration in the wall 30 of each heat exchange tube 2 of a manufactured condenser 1 is the highest at the outermost surface and decreases toward the inside. As a result, the corrosion of the wall 30 occurs uniformly from the outermost surface over the entire wall 30. However, when the Zn powder adhesion amount is less than 2 g/m², this effect is not yielded. When the Zn powder adhesion amount is in excess of 3 g/m², the Zn concentration in the fillets 35 formed in the brazing regions between the heat exchange tubes 2 and the corrugated fins 3 increases. As a result, the spontaneous potential of the fillets 35 becomes lower than the spontaneous potential of the corrugated fins 3, and corrosion of the fillets 35 is accelerated. Therefore, the Zn powder adhesion amount is set to 2 g/m² to 3 g/m².

The reason why the average particle size of the Zn powder is set to 2 to 6 μm and the maximum particle size of the Zn powder is set to be less than 10 μm is as follows. When the average particle size is excessively small, manufacture becomes difficult, and the surface area of the Zn powder increases and the amount of the surface oxide film increases, which results in an increase in the amount of the flux required for removal of the surface oxide film. When the average particle size is excessively large, erosion occurs, and the concentration of Zn after melting of the Zn powder due to heating in a later stage becomes ununiform locally.

The Si powder adhered to the outer surfaces of the heat exchange tubes 2 reacts with Al in the heat exchange tubes 2 and the corrugated fins 3 and is used for brazing of the heat exchange tubes 2 and the corrugated fins 3. However, when the Si powder adhesion amount is less than 3 g/m², the heat exchange tubes 2 and the corrugated fins 3 cannot be brazed well. When the Si powder adhesion amount is in excess of 6 g/m², the dimensional control of products after brazing becomes difficult, whereby the differences between dimensions before the brazing and dimensions after the brazing increase. Therefore, the Si powder adhesion amount is set to 3 g/m² to 6 g/m².

The reason why the average particle size of the Si powder is set to 2 to 6 μm and the maximum particle size of the Si powder is set to be less than 10 μm is as follows. When the average particle size of the Si powder is excessively small, since the surface area of the Si powder increases, a large amount of flux is needed to remove oxide film, and erosion of the heat exchange tubes 2 occurs.

The reason why the amount of the flux powder adhered to the outer surfaces of the heat exchange tubes 2 (i.e., the flux powder adhesion amount) is set to 6 to 24 g/m² is as follows. When the flux powder adhesion amount is less than 6 g/m², removal of oxide film becomes insufficient, and brazing failure may occur. When the flux powder adhesion amount exceeds 24 g/m², the amount of the flux residue increases, which influences the dimensions of the heat exchange core section.

As a result of adhesion of the Zn powder, the Si powder, and the flux powder to the outer surface of each heat exchange tube 2, a flux powder layer containing the Zn powder and the Si powder is formed on the outer surface of the heat exchange tube 2. In the flux powder layer, the Zn powder and the Si powder are uniformly dispersed and held.

Next, the paired header tank body intermediates having the tube insertion holes formed therein are disposed at a predetermined interval; the closing members 12 are disposed at the opposite ends of the respective header tank body intermediates; and the partition plates 7 are disposed in the respective header tank body intermediates. Thus, the header tank intermediates are completed. The heat exchange tubes 2 and the corrugated fins 3 are alternately disposed, and opposite end portions of the heat exchange tubes 2 are inserted into the corresponding tube insertion holes of the header tank intermediates. The side plates 6 are disposed outward of the corrugated fins 3 at opposite ends, and the inlet member 8 and the outlet member 9 are disposed in place.

Subsequently, the header tank intermediates (composed of the header tank body intermediates, the closing members 12, and the partition plates 7), the heat exchange tubes 2, the corrugated fins 3, the side plates 6, the inlet member 8, and the outlet member 9 are temporarily fixed together, thereby yielding a provisional assembly.

Subsequently, the provisional assembly is placed in a brazing furnace and is heated within the brazing furnace such that the temperature of the provisional assembly reaches a predetermined temperature. Notably, flux is applied beforehand to components other than the heat exchange tubes 2 as needed by a publicly known method such as brushing. In the course of increasing the temperature of the provisional assembly, the temperature first reaches the melting point of Zn and the Zn powder melts. However, the molten Zn is dispersed and held in the flux powder layer as in the state before being melted.

When the temperature of the provisional assembly is further increased and reaches a brazing temperature, the flux powder of the flux powder layer melts, thereby breaking oxide films on the outer surfaces of the heat exchange tubes 2, oxide films on the surfaces of the corrugated fins 3, oxide films on particle surfaces of the Si powder, and oxide films on particle surfaces of the Zn powder. Subsequently, Si of the Si powder diffuses in the outer surface layer portions of the heat exchange tubes 2 to thereby form a brazing material of an Al—Si alloy having a low melting point in the outer surface layer portions of the heat exchange tubes 2. The brazing material brazes the heat exchange tubes 2 and the corrugated fins 3. In addition, when the brazing material of the Al—Si alloy having a low melting point is formed in the outer surface layer portions of the heat exchange tubes 2, Zn of the Zn powder and Cu of the outer surface layer portions of the heat exchange tubes 2 enter the brazing material. Therefore, when the brazing material solidifies, the fillets 35 made of an Al—Si—Cu—Zn alloy are formed in the brazing regions between the heat exchange tubes 2 and the corrugated fins 3. Also, the remainder of the Al—Si—Cu—Zn alloy; i.e., the Al—Si—Cu—Zn alloy not used for the formation of the fillets 35 at the time of brazing the heat exchange tubes 2 and the corrugated fins 3, forms the covering layers 32 which cover the outer surfaces of the main body portions 31 of the walls of the heat exchange tubes 2. Further, the diffusion layers 33 containing Si, Cu, and Zn diffused from the covering layers 32 are formed in the outer surface layer portions of the main body portions 31.

Further, simultaneously with the brazing of the heat exchange tubes 2 and the corrugated fins 3, the corresponding corrugated fins 3 and the size plates 6 are brazed. Further, through use of the brazing material of the header tank body intermediates, the heat exchange tubes 2 and the header tank body intermediates are brazed together, and the header tank body intermediates, the closing members 12, and the partition plates 7 are brazed together.

The condenser 1 is manufactured in the above-described manner. The wall 30 of each of the heat exchange tubes 2 of the manufactured condenser 1 is composed of the main body portion 31 made of an Al alloy which forms the above-described aluminum extrudate, and the covering layer 32 which is made of an Al—Si—Cu—Zn alloy and covers the outer surface of the main body portion 31, and the diffusion layer 33 which contains Zn, Si, and Cu diffused thereinto is formed in the outer surface layer portion of the main body portion 31 of each heat exchange tube 2. The spontaneous potential of the main body portion 31 of the wall 30 is higher than that of the outermost surface of the wall 30.

Also, the fillet 35 of made of an Al—Si—Cu—Zn alloy is formed in each of the brazing regions where the corrugated fins 3 are brazed to the heat exchange tubes 2. Preferably, the spontaneous potential of the fillet 35 is the same as that of the outermost surface of the wall 30 of each heat exchange tube 2 or lower than that of the outermost surface of the wall 30 and is higher than that of the corrugated fins 3.

Specific examples of the present invention will now be described along with comparative examples. Condensers having the configuration shown in FIG. 1 were manufactured as the examples and the comparative examples. Notably, in the examples and the comparative examples, there were used heat exchange tubes formed from an extrudate made of an Al alloy containing Cu in an amount of 0.5 mass %, Mn in an amount of 0.2 mass %, Si in an amount of 0.2 mass % or less, Fe in an amount of 0.2 mass % or less, Mg in an amount of 0.05 mass % or less, Cr in an amount of 0.05 mass % or less, Zn in an amount of 0.05 mass % or less, Ti in an amount of 0.05 mass % or less, the balance being Al and unavoidable impurities. The Al alloy forming the heat exchange tubes contains unavoidable impurities other than Si, Fe, Mg, Cr, Zn, and Ti such that individual contents are 0.05 mass % or less and such that the total content is 0.15 mass % or less. Each heat exchange tube has a wall thickness of 225 μm.

### Example 1

There were prepared corrugated fins formed from a bare material made of an Al alloy containing Mn in an amount of 1.25 mass %, Zn in an amount of 1.50 mass %, Si in an amount of 0.6 mass % or less, Fe in an amount of 0.5 mass % or less, and Cu in an amount of 0.05 mass % or less, the balance being Al and unavoidable impurities. Each corrugated fin has a thickness of 70 μm.

Also, there were prepared partition plates, closing members, an inlet member, and an outlet member each having an appropriate alloy composition. Further, each of tank body intermediates having the same shape as the tank bodies was prepared by using a brazing sheet for tank body composed of an aluminum core material having an appropriate alloy composition, and an aluminum brazing material having an appropriate alloy composition and covering opposite surfaces of the core material. Specifically, tube insertion holes were formed in a central portion of the brazing sheet in the width direction thereof, and the brazing sheet was formed into a tubular shape such that opposite side edge portions of the brazing sheet partially overlapped each other. In this state, the opposite side edge portions of each of the tank body intermediates were not brazed to each other.

Further, there were prepared fluoride-based noncorrosive flux powder containing, as a main component, a mixture of KAlF₄ and KAlF₅, Zn powder having an average particle size of 2 to 6 μm and a maximum particle size of less than 10 μm, Si powder having an average particle size of 2 to 6 μm and a maximum particle size of less than 10 μm, a binder in the form of a solution prepared by dissolving acrylic resin in 3-methoxy-3-methyl-1-butanol, and a diluent of 3-methoxy-3-methyl-1-butanol. The Zn powder, the Si powder, and the noncorrosive flux powder were mixedly dispersed in the binder and the diluent, thereby yielding a dispersing liquid. The mixing ratios of all the components of the dispersing liquid are as follows: Zn powder: 8 mass %; Si powder: 13 mass %; noncorrosive flux powder: 25 mass %; binder: 9 mass %; and diluent: balance.

Subsequently, after the heat exchange tubes were heated, the above-described dispersing liquid was applied, by a roll coat process, to the outer surfaces of the heat exchange tubes such that the Si powder adhesion amount became 3.8 g/m², the Zn powder adhesion amount became 2 g/m², the flux powder adhesion amount became 6 g/m², and the binder adhesion amount became 2.5 g/m². Subsequently, the heat exchange tubes were dried within a drying machine for vaporizing the liquid component of the dispersing liquid so as to cause the Si powder, the Zn powder, and the flux powder to adhere to the outer surfaces of the heat exchange tubes.

Next, in the same manner as in the above-described condenser manufacturing method, the header tank intermediates (composed of the header tank body intermediates, the closing members, and the partition plates), the heat exchange tubes, the fins, the side plates, the inlet member, and the outlet member are temporarily fixed together, thereby yielding a provisional assembly.

After that, a nitrogen gas atmosphere was created in a brazing furnace, and the provisional assembly was placed in the brazing furnace. The provisional assembly was heated to a predetermined temperature and was maintained in a predetermined temperature range for a predetermined period of time. As a result, the heat exchange tubes and the corrugated fins were brazed together, and the corresponding corrugated fins and the side plates were brazed together. Further, through use of the brazing material of the tank body intermediates, the heat exchange tubes and the tank body intermediates were brazed together, and the tank body intermediates, the closing members, and the partition plates were brazed together. As a result, the condenser was completed.

### Example 2

A condenser was manufacture in the same manner as in the above-described Example 1 except that the amount of the Zn powder adhered to the outer surfaces of the heat exchange tubes was set to 3 g/m².

### Example 3

A condenser was manufacture in the same manner as in the above-described Example 1 except that the amount of the Si powder adhered to the outer surfaces of the heat exchange tubes was set to 3 g/m².

### Example 4

A condenser was manufacture in the same manner as in the above-described Example 2 except that the amount of the Si powder adhered to the outer surfaces of the heat exchange tubes was set to 3 g/m².

### Comparative Example 1

A condenser was manufacture in the same manner as in the above-described Example 1 except that the amount of the Si powder adhered to the outer surfaces of the heat exchange tubes was set to 1.9 g/m², and the amount of adhesion of the Zn powder to the outer surfaces of the heat exchange tubes was set to 1.5 g/m².

### Comparative Example 2

A condenser was manufacture in the same manner as in the above-described Example 1 except that the amount of the Si powder adhered to the outer surfaces of the heat exchange tubes was set to 2.5 g/m², and the amount of the Zn powder adhered to the outer surfaces of the heat exchange tubes was set to 2 g/m².

### Comparative Example 3

A condenser was manufacture in the same manner as in the above-described Example 1 except that the amount of the Si powder adhered to the outer surfaces of the heat exchange tubes was set to 3 g/m², and the amount of the Zn powder adhered to the outer surfaces of the heat exchange tubes was set to 6 g/m².

### Comparative Example 4

A condenser was manufacture in the same manner as in the above-described Example 1 except that the Zn content of the Al alloy forming the aluminum-bear-material-made corrugated fins was set to 0.7 mass %, the amount of the Si powder adhered to the outer surfaces of the heat exchange tubes was set to 3 g/m², and the amount of the Zn powder adhered to the outer surfaces of the heat exchange tubes was set to 5 g/m².

### Comparative Example 5

A condenser was manufacture in the same manner as in the above-described Example 1 except that the Zn content of the Al alloy forming the aluminum-bear-material-made corrugated fins was set to 0.7 mass %, the amount of the Si powder adhered to the outer surfaces of the heat exchange tubes was set to 3 g/m², and the amount of the Zn powder adhered to the outer surfaces of the heat exchange tubes was set to 6 g/m².

### Comparative Example 6

A condenser was manufacture in the same manner as in the above-described Example 1 except for the following.

There were used corrugated fins formed from a brazing sheet having a thickness of 80 μm and composed of an aluminum core material and an aluminum brazing material covering the opposite surfaces of the core material. The aluminum core material contained Zn in an amount of 2.2 mass % and Mn in an amount of 1.25 mass %, the balance being Al and unavoidable impurities. The aluminum brazing material contained Si in an amount of 9 mass % and Cu in an amount of 0.4 mass %, the balance being Al and unavoidable impurities.

Also, a Zn sprayed coating was formed on the outer surface of each heat exchange tube by thermal spraying such that Zn was sprayed in an amount of 5.5 g/m².

### Evaluation Test 1:

The ratio of joining between the heat exchange tubes and the corrugated fins in each of the condensers manufactured in Example 1, Comparative Example 1, and Comparative Example 2 was investigated. The results show that the joining ratio was 98.6% in the condenser of Example 1, the joining ratio was 88.7% in the condenser of Comparative Example 1, and the joining ratio was 94.9% in the condenser of Comparative Example 2. Notably, whereas stable brazing was performed in Example 1 in which the amount of the Si powder adhered to the outer surfaces of the heat exchange tubes was 3 g/m² or greater, brazing was insufficient in Comparative Examples 1 and 2 in which the amount of the Si powder adhered to the outer surfaces of the heat exchange tubes was less than 3 g/m².

### Evaluation Test 2:

There were measured the spontaneous potentials of the wall outermost surface and the wall main body portion of each heat exchange tube of each of the condensers manufactured in Examples 1 and 2 and Comparative Example 6, the spontaneous potential of each corrugated fin of each of the condensers manufactured in Examples 1 to 4 and Comparative Examples 3 to 5, the spontaneous potential of the core material-made portion of each corrugated fin of the condenser manufactured in Comparative Example 6, and the spontaneous potential of the fillet formed in each of the brazing region between the heat exchange tubes and the corrugated fins in each of the condensers manufactured in Examples 1 to 4 and Comparative Examples 3 to 6. Table 1 shows the results of the measurement. Notably, in Table 1, the core material-made portion of each corrugated fin of the condenser manufactured in Comparative Example 6 is treated as a fin.

TABLE 1

| | | | | | | Potential | |
|---|---|---|---|---|---|---|---|
| | | Spontaneous potential (mV) | | | | difference | |
| | | Outermost | Main body | | | (outermost | Potential |
| | | surface of | portion of | | | surface of tube | difference |
| | | tube wall | tube wall | Fin | Fillet | wall − fin) | (fillet − fin) |
| Example | 1 | −729 | −709 | −834 | −737 | 105 | 97 |
| | 2 | −737 | −709 | −850 | −748 | 113 | 102 |
| | 3 | | | −834 | −737 | | 97 |
| | 4 | | | −847 | −760 | | 87 |
| Comparative | 3 | | | −868 | −814 | | 54 |
| Example | 4 | | | −775 | −793 | | −18 |
| | 5 | | | −778 | −806 | | −28 |
| | 6 | −810 | −695 | −695 | −850 | −115 | −155 |

Further, an SWAAT test (40 days) was carried out for the condensers manufactured in Examples 1, 3, and 4 and Comparative Examples 3 to 6, and their corrosion states were investigated.

The results show the following. In the condensers manufactured in Examples 1, 3, and 4, the progress of corrosion of the outer surfaces of the heat exchange tubes, the progress of corrosion of portions of the corrugated fins in the vicinity of the regions where the corrugated fins were brazed to the heat exchange tubes, and the progress of corrosion of the fillets were suppressed. In contrast, in the condensers manufactured in Comparative Examples 3 to 6, the corrosion of the outer surfaces of the heat exchange tubes, the corrosion of portions of the corrugated fins in the vicinity of the regions where the corrugated fins were brazed to the heat exchange tubes, and the corrosion of the fillets progressed, pitting corrosion having a large maximum corrosion depth occurred in a large area of the outer surface of each heat exchange tube, and separation of the corrugated fins due to disappearance of the fillets occurred.

The present invention comprises the following mode. 1) A method for manufacturing a heat exchanger which includes heat exchange tubes made of aluminum and fins made of aluminum and brazed to the heat exchange tubes, the method comprising:

preparing heat exchange tubes formed from an aluminum extrudate made of an alloy containing Mn in an amount of 0.1 to 0.3 mass %, Cu in an amount of 0.4 to 0.5 mass %, Si in an amount of 0.2 mass % or less, Fe in an amount of 0.2 mass % or less, Zn in an amount of 0.05 mass % or less, and Ti in an amount of 0.05 mass % or less, the balance being Al and unavoidable impurities;

preparing fins formed from an aluminum bare material made of an alloy containing Mn in an amount of 1.0 to 1.5 mass %, Zn in an amount of 1.2 to 1.8 mass %, Si in an amount of 0.6 mass % or less, Fe in an amount of 0.5 mass % or less, and Cu in an amount of 0.05 mass % or less, the balance being Al and unavoidable impurities;

applying a dispersing liquid, which is prepared by mixedly dispersing Zn powder, Si powder, and flux powder in a binder, to outer surfaces of the heat exchange tubes and vaporizing a liquid component in the dispersing liquid, thereby causing the Zn powder, the Si powder, and the flux powder to adhere to the outer surfaces of the heat exchange tubes such that the amount of adhered Zn powder becomes 2 to 3 g/m², the amount of adhered Si powder becomes 3 to 6 g/m², and the amount of adhered flux powder becomes 6 to 24 g/m²; and

heating an assembly of the heat exchange tubes and the fins within a brazing furnace so as to braze the heat exchange tubes and the fins together by utilizing the Si powder and the flux powder adhered to the outer surfaces of the heat exchange tubes.

In the heat exchanger manufactured by the method of par. 1), a fillet made of an Al—Si—Cu—Zn alloy is formed in each of brazing regions between the heat exchange tubes and the fins. Specifically, when an assembly of the heat exchange tubes and the fins is heated in a brazing furnace, the flux powder first melts, thereby breaking oxide films on the outer surfaces of the heat exchange tubes, oxide films on the outer surfaces of the fins, oxide films on particle surfaces of the Si powder, and oxide films on particle surfaces of the Zn powder. Subsequently, Si of the Si powder diffuses in the outer surface layer portions of the heat exchange tubes to thereby form a brazing material of an Al—Si alloy having a low melting point in the outer surface layer portions of the heat exchange tubes. The brazing material brazes the heat exchange tubes and the corrugated fins. In addition, when the brazing material of the Al—Si alloy having a low melting point is formed in the outer surface layer portions of the heat exchange tubes, Zn of the Zn powder and Cu of the outer surface layer portions of the heat exchange tubes enter the brazing material. Therefore, when the brazing material solidifies, fillets made of an Al—Si—Cu—Zn alloy are formed in the brazing regions between the heat exchange tubes and the corrugated fins. Also, the wall of each heat exchange tube includes a main body portion made of the Al alloy forming the extrudate, a covering layer made of an Al—Si—Cu—Zn alloy and covering the outer surface of the main body portion, and a diffusion layer which is formed in an outer surface layer portion of the main body portion and into which Si, Cu, and Zn of the covering layer are diffused. Since the fins are formed from an aluminum bare material, the fins have enhanced corrosion resistance as compared with a heat exchanger manufactured by the method disclosed in Japanese Patent Application Laid-Open No. 2014-238209 in which the fins are formed from an aluminum brazing sheet. Also, the spontaneous potential of each fin can be made lower than the spontaneous potentials of the outermost surface and the main body portion of the wall of each heat exchange tube, and the spontaneous potential of the fillet formed in each of the brazing regions between the heat exchange tubes and the fins. As a result, the corrosion resistance of the heat exchange tubes can be enhanced by the sacrificial corrosion action of the fins, and disappearance of the fillets within a short period of time due to corrosion can be prevented, whereby fin separation can be prevented over a long period of time.

What is claimed is:

1. A method for manufacturing a heat exchanger which includes heat exchange tubes made of aluminum and fins made of aluminum and brazed to the heat exchange tubes, the method comprising:
preparing heat exchange tubes formed from an aluminum extrudate made of an alloy containing Mn in an amount of 0.1 to 0.3 mass %, Cu in an amount of 0.4 to 0.5 mass %, Si in an amount of 0.2 mass % or less, Fe in an amount of 0.2 mass % or less, Zn in an amount of 0.05 mass % or less, and Ti in an amount of 0.05 mass % or less, the balance being Al and unavoidable impurities;
preparing fins formed from an aluminum bare material made of an alloy containing Mn in an amount of 1.0 to 1.5 mass %, Zn in an amount of 1.2 to 1.8 mass %, Si in an amount of 0.6 mass % or less, Fe in an amount of 0.5 mass % or less, and Cu in an amount of 0.05 mass % or less, the balance being Al and unavoidable impurities;
applying a dispersing liquid, which is prepared by mixedly dispersing Zn powder, Si powder, and flux powder in a binder, to outer surfaces of the heat exchange tubes and vaporizing a liquid component in the dispersing liquid, thereby causing the Zn powder, the Si powder, and the flux powder to adhere to the outer surfaces of the heat exchange tubes such that the amount of adhered Zn powder becomes 2 to 3 g/m², the amount of adhered Si powder becomes 3 to 6 g/m², and the amount of adhered flux powder becomes 6 to 24 g/m²; and
heating an assembly of the heat exchange tubes and the fins within a brazing furnace so as to braze the heat exchange tubes and the fins together by utilizing the Si powder and the flux powder adhered to the outer surfaces of the heat exchange tubes.
